(19) United States
(12) Patent Application Publication
(10) Pub. No.: US 2025/0077706 A1
(43) Pub. Date: Mar. 6, 2025

(54) UNIVERSAL THIRD PARTY PRIVACY AND PERSONAL DATA MANAGEMENT SYSTEM

(71) Applicant: Charles Finkelstein Consulting LLC, Woodinville, WA (US)

(72) Inventors: Charles Finkelstein, Woodinville, WA (US); Ethan Finkelstein, Woodinville, WA (US)

(73) Assignee: Charles Finkelstein Consulting LLC, Woodinville, WA (US)

(21) Appl. No.: 18/949,729

(22) Filed: Nov. 15, 2024

Related U.S. Application Data
(63) Continuation of application No. 17/856,390, filed on Jul. 1, 2022.

(51) Int. Cl. G06F 21/62

(52) U.S. Cl. CPC G06F 21/6245

(57) ABSTRACT

A universal opt-in/opt-out client enables a user to connect to the APIs for various different sites which have the user's data. The universal client and orchestrates opting out on any of the sites which the user selects and enables the user to granularly select partial opt-ins or opt-outs where the user may wish to enable some uses of data and access to data, but would also like to restrict others. When a user is calibrating their privacy and data settings, a company or site may provide reasons and incentives for the user to enable access to certain data. This enables users to have simultaneous global control over their personal data while enabling the user to receive compensation for the use of their personal data, and enabling companies to have access to better data.

### CROSS REFERENCE TO RELATED APPLICATIONS

This application claims priority and benefit as a continuation of application Ser. No. 17/856,390, “UNIVERSAL THIRD PARTY PRIVACY AND PERSONAL DATA MANAGEMENT SYSTEM”, filed on Jul. 1, 2022, the contents of which are incorporated herein by reference in their entirety.

### BACKGROUND

Big data is an important driving force behind the global economy. Having access to data enables companies to provide free and personalized services to people. However, most people are not aware who has their data, what data is, what is being done with it, how to correct it, or how to opt in or out of its use. They are not aware what their data is worth nor how they are compensated for companies' access to their data. Companies make billions of dollars, capturing and selling consumer data. Worldwide, consumer data is estimated to be worth over $230 billion. Today search engines and social networking site know far more about users than most people realize. Sites aggregate information that tells them who users are, what they do, and how they think.

While access to consumer data has allowed companies to make money, these companies sometimes violate policies, get hacked, and are often slow to be compliant with new regulations. There has been rising concern among consumers about their lack of control over personal data. These fears have been compounded by a number of high-profile data breaches. In one instance, the personal data for over 145 million Americans was stolen. There has been an increasing focus on personal data and its link to privacy.

Privacy laws are becoming increasingly focused on protecting user data. The US Federal Trade Commission's consumer protection laws have been evolving to help protect consumer data and give consumers knowledge and control. For example, enabling consumers to see their credit score, is now required for free. Europe and Canada have taken an even more aggressive approach than the United States. The EU passed legislation, most notably, the General Data Protection Regulation (GDPR), with the intent of giving citizens and residents control over their personal data and to simplify the regulatory environment for international business. In Canada, similar privacy-centered legislation has also been enacted.

In order to be compliant with laws like the GDPR, companies are providing basic interfaces where the user may enter their name and select whether or not they would like to opt-in or out of certain privacy-centered features. Despite the value of personal data, and the resources companies devote to obtaining it, a large portion of data harvested is inaccurate. Companies need a better way to give transparency with privacy and content control to consumers around their personal data. Companies want but don't get current, accurate personal data and people want better goods and services while maintaining personal control of their data. There is an increasing need for companies to have an efficient way to obtain user data securely, while enabling the user to opt in or out, manage privacy settings, retain control of data content, and be incentivized for its use.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts a personal data management system 100 in one embodiment.

FIG. 2 depicts a process for managing personal data 200 in accordance with one embodiment.

FIG. 3 depicts a process for managing ID health 300 in accordance with one embodiment.

FIG. 4 depicts a reward and data sharing process 400 in accordance with one embodiment.

FIG. 5 depicts a data privacy system 500 in accordance with one embodiment.

FIG. 6 depicts a data privacy system 600 in accordance with one embodiment.

FIG. 7 depicts a data privacy system 700 in accordance with one embodiment.

FIG. 8 depicts a system 800 for third-party management of data privacy, in one embodiment.

FIG. 9 depicts blockchain 900 in accordance with one embodiment.

FIG. 10 depicts a digital apparatus 1000 in accordance with one embodiment.

### DETAILED DESCRIPTION

Enterprises often utilize and operate an Identity and Access Management System (IAM). Microsoft Active Directory is one well-known example. Disclosed herein are systems that integrate with enterprise IAMs to manage employee's privacy settings and personal data sharing with networked devices (such as web applications, Internet of Things, and websites). Management may be role-based or individual-based, with the latter overriding role-based or vice versa, depending on the circumstances. The disclosed systems may also integrate with enterprise Mobile Device Management (MDM) systems, where by the management of those devices or partitions of those devices are mapped to MDM policies extended for control of personal data sharing.

Individuals may assume one or more of multiple ‘identities’ when operating online. These identities may or may not be linked. An individual may, for example, segregate use of work devices from personal devices, and likewise do so for online identities (e.g., authentication credentials and accounts with websites or networked devices). It is also common for an individual to operate a single device under multiple identities, for example a laptop computer, tablet, or mobile phone. In either situation, an entity that employs the individual may seek control over the sharing of data, especially private or sensitive data of the entity or individual, if sharing that data with other devices, applications, or websites might compromise the entity or individual somehow.

Employees and contractors interact with networked devices, applications, and systems as a matter of normal business course. Many websites today gather information about these individuals, resulting in the company's data that being surreptitiously taken, monetized, and possibly abused. Employees do business work, on company equipment and networks using their corporate identity/roles, (e.g., the employees work email address, cookies that show company access, etc.). The company may desire to manage, set, and enforce privacy and data sharing policies for employee's that interact with external devices, applications, and systems. Because employees also have individual identities online, and may even have multiple identities/roles within the company, or with multiple companies in the case of third-party vendors and contractors, such policies and settings may advantageously be role-based. They may also be specific to interactions with particular websites, applications, and/or online devices.

Conventional systems enable users to log in and authenticate, apply roles granted to the user for access to management of specific datasets, and apply current access management policy(s) granted to the user. However systems in accordance with the disclosed embodiments enable filtering of actionable operation(s) by application of digital contract entitlement and enable user actions on data constrained by role-specific entitlements by roles, specifically privacy and personal data regulations encoded in a smart contract, e.g., on a blockchain. The blockchain may encode renewal dates, expiration dates, auto renewal status, and conditional renewal circumstances for particular geopolitical regions (for example). Other embodiments may encode the privacy constraints and entitlements as extensions to conventional authentication and/or digital rights and entitlement management systems.

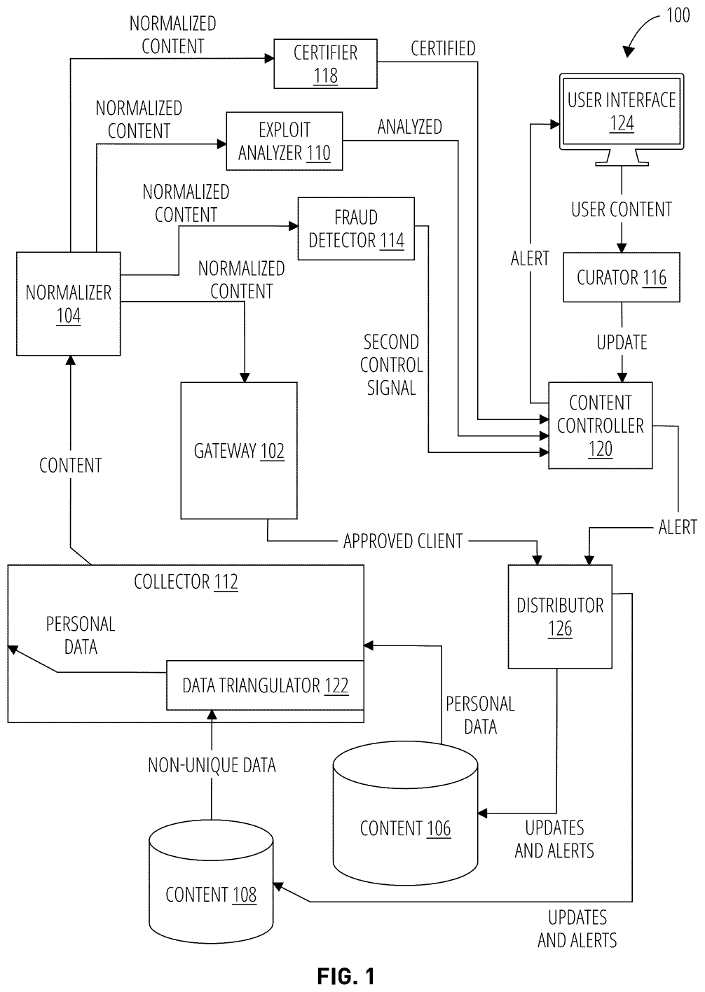

Referring to FIG. 1, a system 100 comprises a gateway 102, a normalizer 104, content 106, content 108, an exploit analyzer 110, a collector 112, a fraud detector 114, a curator 116, a certifier 118, a content controller 120, a data triangulator 122, a user interface 124, and a distributor 126.

The collector 112 receives the content 106 and content 108 and in response collects the content for normalization and distribution to various management modules. Content may be collected into a buffer, for example a FIFO, or may be processed immediately, or may be buffered and prioritized for processing according to source. Content sources include local devices (PC, LAN server, tablet, mobile phone, etc.), “cloud” locations, and any source that stores data components representing a person or entity explicitly or in an obfuscated fashion, (e.g. GUID).

Content sources may be accessed utilizing a driver model. The system may include specific data source “connectors” built on generic interfaces that call the most optimal methods for gaining access to the source(s), then collecting/distributing data back. For example, local file and/or database methods with local access controls may be utilized for locally accessible data stores, e.g. mounted file systems. In the case of accessing personal data on a social network, ecommerce site, or financial data warehouse, specific data connectors are built, and loaded, utilizing methods such as REST, JSON, SOAP, Protocol Buffers, and others as appropriate to verify credentials, collect content, distribute updates, etc. Some sources may require subscriptions or some other secure method to access; for example a person may pay also store personal information such as financial accounts and passwords in an encrypted removable device, such as to make it virtually un-hackable.

In some embodiments, a collector 112 receives a unique human-associated digital identifier from content 106 and transforms it into a digital content. The data triangulator 122 receives a non-unique digital pattern from content 108 and correlates identified data to existing data and transforms a non-unique digital pattern into a unique human-associated digital identifier. The collector 112 transforms personal data signals into a digital content which it transmits to normalizer 104.

The normalizer 104 receives a digital content and transforms it into normalized content by identifying content attributes and standardizing data formatting. Normalization involves mapping data fields having possibly different names or values across different content sources to consistent names or values for analysis and processing by the various management modules. The normalized content is then distributed to the various management modules.

The certifier 118 receives a normalized content from the normalizer 104 and in response transforms it into a content certification and transmits the content certification to the content controller 120. The content controller 120 receives this alert from the certifier 118 and in response maps the alert to the specific form of the source to which it will be provided, such a user interface 124 which presents a person (principle or delegate) with an option to certify the veracity of the content. If the content is validly associated with the person, they may provide an alert indicating its validity. The alert may be passed back to the appropriate content sources which provide an indication that the content is certified by its “owner”, that is, the person it is for/about. If the content is not validly associated with the person, a different alert (indicating the content is uncertified) may be generated and passed through to the content sources, which post a corresponding “uncertified” indication for the content.

The exploit analyzer 110 receives a normalized content and in response analyzes the content for exploitation of personal data and transforms it into a first control signal and transmits it to a content controller 120. Exploitation may involve use of personal data for monetary gain, without authorization to do so. Detected exploitation may be reported to the person whose data is being exploited using a machine-human interface. The person may choose to act to end the exploitation by contacting the content source or the person exploiting the content.

The fraud detector 114 receives a normalized content and in response analyzes the content for fraudulent actions and transforms it into a first control signal and transmits it to a content controller 120. Fraudulent activity can include false attribution of the content to a person or entity; false or misleading statements in conjunction with the content; or other use of the content in a fraudulent or misleading manner. If fraud is detected, an alert may be generated for distribution back to the content source. The gateway 102 receives the alert from the fraud detector 114 and in response maps the alert to the specific form of the source to which it will be provided. The distributor 126 receives the alert from the content controller 120 and in response distributes the alert to the appropriate content sources. The content sources 106, 108 receive the content update signal from distributor 126 which may include an alert and in response act on the alert, for example by removing or flagging the corresponding content.

The curator 116 receives user content from a user interface 124 and transforms the digital content into a third control signal and transmits it to content controller 120.

The content controller 120 receives a third control signal, a second control signal, a first control signal, and a content certification, and sends a combined control signal to operate gateway 102 and transmit an enable signal to collector 112.

The content controller 120 receives a third control signal, a second control signal, a first control signal and a content certification and sends an alert to user interface 124 to notify the user of the need for additional action or approval.

The distributor 126 receives an approved content and alert and sends updates and alerts signal to content 106 and content 108.

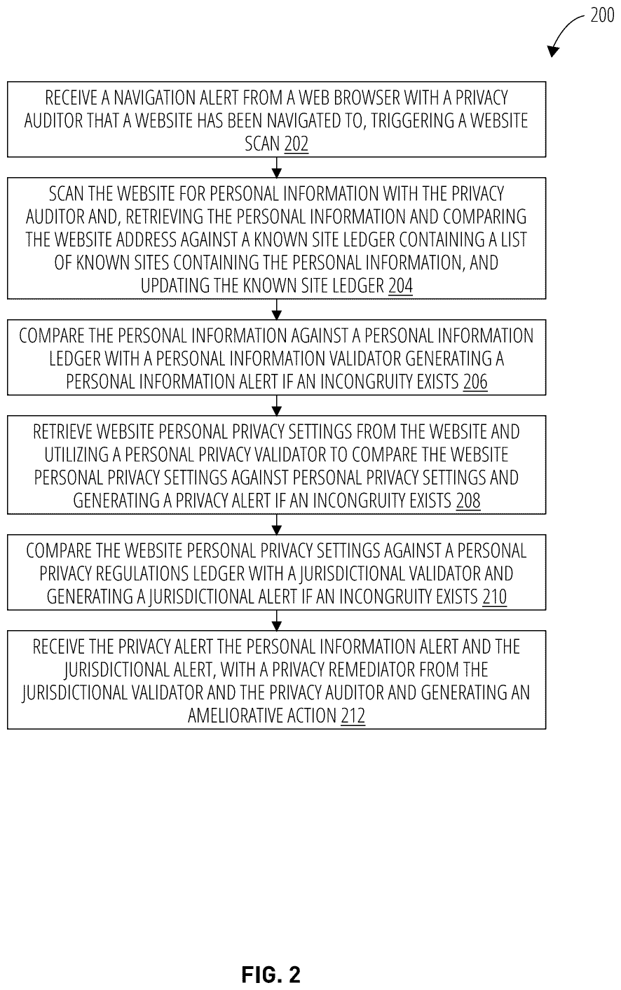

Referring to FIG. 2, a process for managing personal data 200 receives a navigation alert from a web browser with a privacy auditor that a website has been navigated to, triggers a website scan (block 202).

The process for managing personal data 200 scans the website for personal information with the privacy auditor, and retrieves the personal information and compares the website address against a known site ledger contains a list of known sites contains the personal information, and updates the known site ledger (block 204).

The process for managing personal data 200 compares the personal information against a personal information ledger with a personal information validator, and generates a personal information alert if an incongruity exists (block 206).

The process for managing personal data 200 retrieves website personal privacy settings from the website or distributed application, and utilizes a personal privacy validator to compare the website personal privacy settings against personal privacy settings, and generates a privacy alert if an incongruity exists (block 208).

The process for managing personal data 200 compares the website personal privacy settings against a personal privacy regulations ledger with a jurisdictional validator, and generates a jurisdictional alert if an incongruity exists (block 210).

The process for managing personal data 200 and receives the privacy alert the personal information alert and the jurisdictional alert, with a privacy remediator from the jurisdictional validator and the privacy auditor, and generates an ameliorative action (block 212).

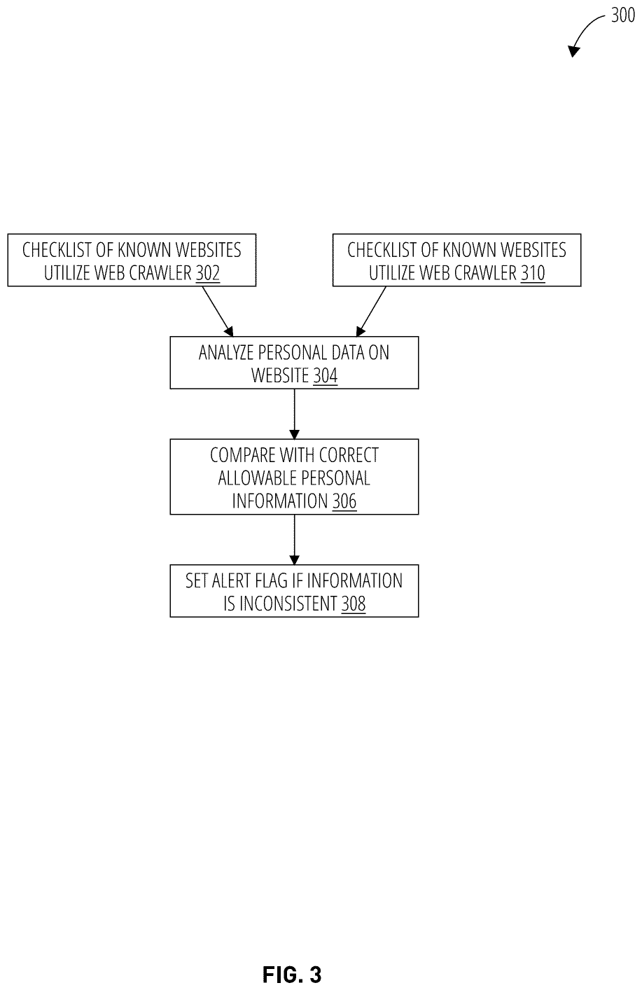

Referring to FIG. 3, a process for managing ID health 300 checks the current website for personal data (block 302). The process for managing ID health 300 utilizes a browser to check a list of known websites (block 304). The process for managing ID health 300 analyzes personal data on the website (block 306), and compares the personal data on the website with correct and allowable personal information (block 308). An alert flag is set if the information is inconsistent (block 310).

A system may utilize this process to monitor the users identity health (ID health) by monitoring outlets with the user's personal information and looking for any inconsistency with the user's actual data, in which case the system will generate an alert. The system may batch scan known sites and may also crawl websites and distributed applications, and may also utilize a central repository with an API to enable companies to request verification of identification. For example, a credit card company may receive a request for a new credit card from a person using the user's information. The credit card company could transmit information to the system via a secure connection for verification, and in the event that the request was false, the system may generate an alert to the credit card company as well as recording the attempt and notifying the user. The system may monitor user information posted on the Internet and look for known issues. For example, the system may use a blacklist of sites and interactions that that have known to corrupt identity, and may intervene if any of those sites come up in the record of data use.

The system may also utilize blockchain to record transactions in an immutable ledger. For example, user privacy settings may be recorded on the blockchain with time and date stamps. The blockchain may also enable a self-sovereign ID, which may begin as a global unique user ID (GUID) with various levels of attestations upon it, such as a user's certified social security number, certified driver's license, or certified passport, as well as professional certifications. The user may make changes to their personal settings, where the user opts out of certain settings which would become a transaction on the blockchain, and any future transactions that switch it back would be recorded on the blockchain as well. The system may monitor these transactions and look for inconsistencies that indicate that the user's identity has been compromised. The system may also record on the ledger times/dates that information within the ledger was accessed. A user may use the system's app or browser extension to record on the block chain that some that the user's personal information was read from a particular site or distributed application.

Companies may update their privacy policies to be in compliance with laws, for example the GDPR, so the system may periodically query companies for updates of their privacy policy, and updates from governmental agencies on privacy regulations.

For example, the system may alert a company administrator that a privacy policy has been affected by a regulation change so that the administrator could check to see how it affects the business rules and alter the company's privacy policy.

The system may employ a validator in forms that may include blockchain smart contracts to compare privacy settings with current laws, and user preferences and then may execute an action based on that. In the event that an error is found, then the validator may generate an alert notifying the site or user of the potential discrepancy. They system may embody this business rules/legal flows utilizing standard orchestration scripting or blockchain smart contracts well known in the art. The system may also embody these rules and flows in a blockchain which would automatically also record the transaction to a ledger in an immutable way. For example, if a user participates in a transaction, e.g. updating their privacy policy or opt-in/opt-out, this could be verified against the smart contract that the policy was either written manually or auto imported which would ensure that transaction is compliant.

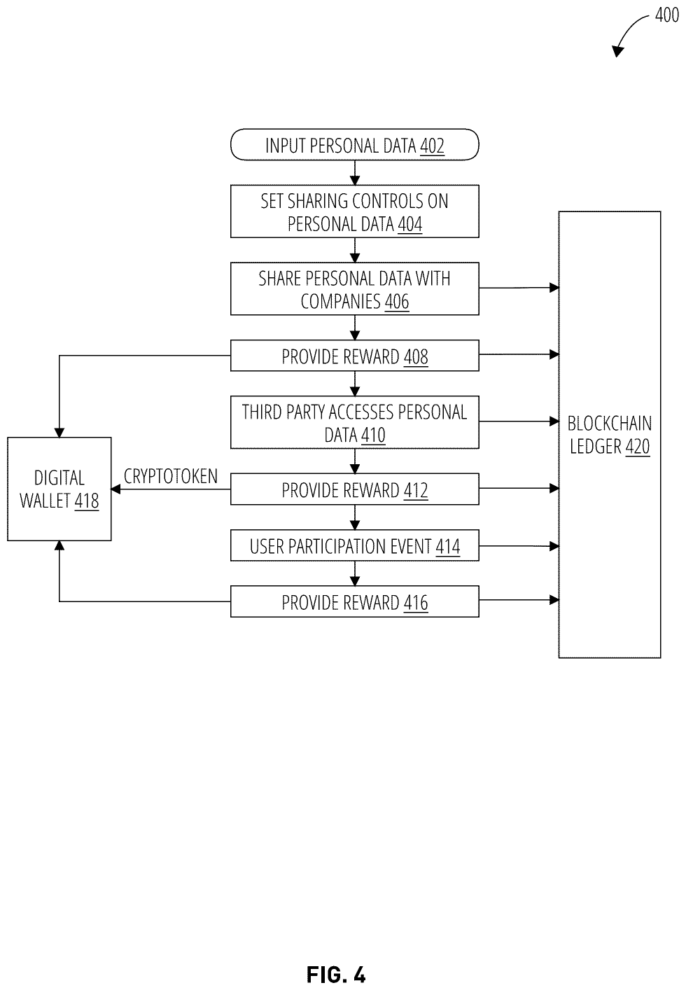

Referring to FIG. 4, a reward and data sharing process 400 begins by inputting personal data (block 402) and setting sharing controls on the personal data (block 404).

The reward and data sharing process 400 shares personal data with companies (block 406), and provides a reward via a digital wallet (block 408). The reward and data sharing process 400 provides third party access to the personal data (block 410).

The reward and data sharing process 400 provides a reward via a digital wallet (block 412), initiates a user participation event (block 414), and provides a reward (block 416).

The rewards in block 408, block 412, and block 416 may be deposited in the digital wallet 418 as a cryptotoken. The transactions in block 406, block 408, block 410, block 412, block 414, and block 416, are recorded on the blockchain ledger 420.

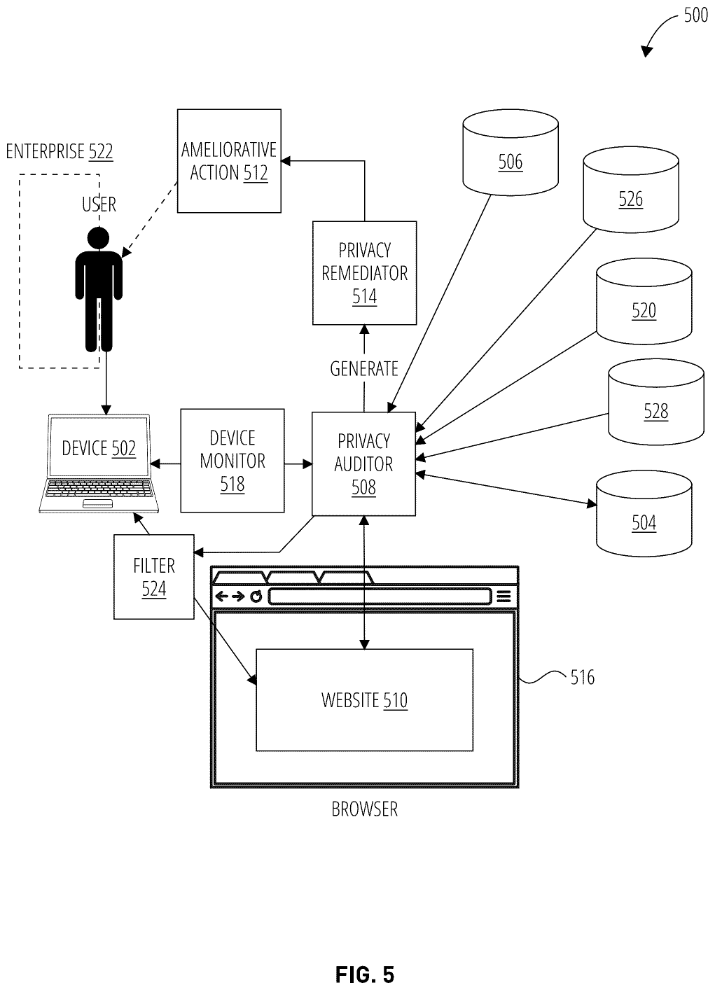

Referring now to FIG. 5, a data privacy system 500 comprises a device 502, personal privacy ledger 504, a personal privacy regulations ledger 506, a privacy auditor 508, an enterprise privacy regulations ledger 526, an enterprise privacy settings ledger 528, a website 510, an ameliorative action 512, a privacy remediator 514, and a browser 516.

A universal privacy settings/opt-in/opt-out client enables a user to connect to the APIs for various different sites which have the user's data. The universal client orchestrates curation of privacy settings and overall opting out of any of the sites which the user selects. It enables the user to granularly select partial opt-ins or opt-outs where the user may wish to enable some uses of data and access to data but would restrict others.

When a user is calibrating their privacy and data settings, a company or site or distributed application may provide reasons and incentives for the user to enable access to certain data. This enables users to have simultaneous global control over their personal data while enabling the user to receive compensation and/or services for the use of their personal data, thus enabling companies to have access to better data. The user may do this by maintaining a universal profile with a personal privacy policy which may be applied to company privacy policies and the system may then automatically resolve where the two are in conflict.

Common settings across sites have a unified view and unique settings per site are labeled, with a site identifier. This would enable the user's data and privacy settings to remain consistent across sites, where common data and settings are used and uniquely where required by individual sites. The user may authenticate the system into web sites and decentralized services and authorize its access to the sites utilizing the user's credentials. And where blockchain IDs are used, the system may similarly operate on behavior of the user. For example, after the user has installed the system's user portion, a user may use a mobile device or computer to go to a site or decentralized service, for example, Facebook® or Steemit.

The first time the user does this, the system may automatically generate a pop-up window or notification and ask the user for their settings, enabling the system to auto configure based on the user's online behavior. This enables the user greater freedom to use the most efficient software for their purpose since the user is not forced to access sites through the system, which runs parallel to, or in the user's browser. The system may run in the background (like a daemon) and monitor sites unobtrusively.

The system may then see that the user accessed a site or decentralized service that had contained the user's personal data. The system may inquire how the user would like to have their data managed on that site. The system may enable the user to also configure when the system is running. The system may for example enable the user to toggle the system off and on or enable the user to set specific instances or sites which should be explicitly included or excluded (i.e. “whitelisted” or “blacklisted”), or may enable the user to “suspend” protection if desired.

When that site or decentralized service is accessed in the future, the system will enforce the privacy settings through the browser or interface used to access that site or it would automatically configure the user's profile. For example, a user's Facebook profile may be automatically configured to reflect the user's preferences for that site or decentralized service.

The system may need to synchronize with privacy settings that the user has changed manually and may as the user to resolve/approve conflicts. When the system connects to the site or decentralized service's privacy settings or opt-in/opt-out settings, the system may evaluate the settings to see if the user had changed any. The system may access a site or decentralized service through an API or more directly through “web scraping” and may employ the user's ID and credentials to gain access. The system may utilize an intermediary to analyze the settings and do a manual translation until the system can gain access to the site. The system may maintain a database of known personal data aggregating sites and may connect to those sites to correct or request removal of personal information depending on the user's settings. The system may also be configured with a country's privacy laws and may monitor information on websites and decentralized services for compliance with both the user's settings as well as the privacy laws of that jurisdiction. For example a user may elect to exercise their “right to be forgotten” under the GDPR, and the system may make adjustments as necessary and remove the information specified by the user.

For example, the user may look at some of the settings common to the different sites and employ a translator layer with a portable JSON configuration standard to enable system to easily control privacy across sites and decentralized services.

The system may employ a browser extension to detect that a site was a data miner and may check the user's privacy settings for that site to ensure consistency with either the user's default settings or some special settings the user may have for that particular site, and if the settings on the site were inconsistent with the user's settings, the system would automatically set the sites settings to be consistent, or notify the user and site admin of the inconsistency.

In one embodiment a device monitor 518 determines device type and other attributes of a user's device and device activity, and provides this information the privacy auditor 508 that selects from a harmonization and prioritization of control settings in a personal privacy settings ledger 504, enterprise privacy settings ledger 528, enterprise privacy regulations ledger 526, and enterprise role policies 520 for control of the privacy auditor 508. Commercial embodiments of device monitors 518 perform functions such as IP address detection, device operating system type detection, and device make and model detection. They may also monitor user activity on devices, such as keystrokes, website accesses, and the network addresses or identities of computer systems, individuals, applications, and/or entities that a user of a device interacts with.

In many organizations, a person may take on multiple roles, each with a different scope of responsibilities, and the enterprise role policies 520 may reflect this fact. Thus a particular user may take on multiple identities for purposes of data sharing, for example their individual identity and one or more identities (roles) in the one or more enterprises 522. A user may identify the role they are operating a device under (e.g., explicitly using authentication credentials specific to that role), or the device monitor 518 may determine a most likely or default role for the user, based on their device activity. The role/identity a user is operating under in a particular circumstance may be provided either directly or via the device monitor 518 to the privacy auditor 508. The privacy auditor 508 in turn may access and configure operational control settings reflecting the appropriate one or more of the enterprise role policies 520 for the determined role/identity, either generally or for the particular user (the enterprise role policies 520 may be customized, via hierarchical settings, to particular users).

The privacy auditor 508 ingests rules (e.g., rules encoded as a smart contract on a blockchain) that map to appropriate constraints (e.g. location, entity type, usage etc.), harmonizes the constraints based on a prioritization (e.g., federal constraints take precedence over local ones), and enforces that accesses, movements, transfers, etc. of private data complices with the constraints.

For example the privacy settings may indicate that a corporation owns all corporate personnel data and may permit the corporations to perform data-mining and analytics on this data. The encoded constraints may indicate that the corporation may sell or license metadata about the personnel data, such a percentage of its employees that opt out of sharing the usage of third-party web sites and devices. In another example, the constraints may specify that a third party data and/or privacy management service may share some anonymized information about customers trends.

An example of a constraint that may be encoded in a smart contract is a geopolitical regulation requiring storage of certain personal data in-country for 28 days beyond which the data must be anonymized.

In some circumstances, through a hierarchical configuration of control settings, the enterprise role policies 520 may supervene on (take precedence over) the personal privacy settings ledger 504, even when the user is operating through the device 502 under their individual identity. For example, the enterprise role policies 520 may restrict the type or subject matter of information a person may communicate or share publicly or privately online in both of their individual identity and in the capacity of any or some enterprise roles (e.g., because it involves trade secrets or reflects poorly on the enterprise). To mitigate risks to the enterprise from data leaks, the enterprise role policies 520 may restrict the type of website that can access the user's personal information. The privacy auditor 508 may activate a filter 524 if the enterprise role policies 520 determine that unauthorized or sensitive personal or corporate information, or forbidden content, is being shared to a website 510 or online application, for example. Filtering may be further configured for particular user devices 502, or for users in or assigned a particular role (e.g., upper management role) of the enterprise. The filter 524 may block or restrict information flow, or may alert the user of possible violations of the enterprise role policies 520 (in some cases, even when the user is operating in their sovereign role as an individual, not an enterprise role).

One or more of the personal privacy regulations ledger 506, enterprise role policies 520, and personal privacy settings ledger 504 may be implemented on a blockchain, for example as smart contracts.

In one embodiment the filter 524 comprises an artificial intelligence component such as a bot agent. Rather than block the user outright from sharing certain content, the filter 524 may provide suggestions or modifications to what the user can or should share or attempt to share, based for example on the enterprise role policies 520. For example the filter 524, implemented as a bot agent, may detect that the user is interacting with a website from an enterprise device 502, which could result in collection by the website of restricted enterprise data. The filter 524 may then either prevent the interaction, block or modify the sensitive information before it reaches the website, or merely suggest alternative, approved websites for the interaction.

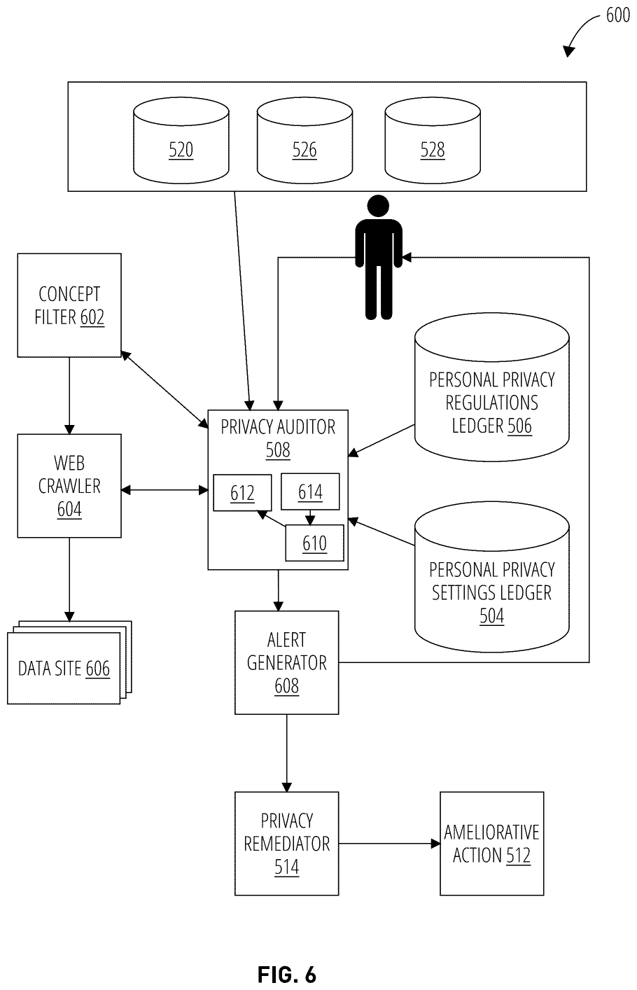

Referring to FIG. 6, the data privacy system 600 comprises a personal privacy settings 504, a personal privacy regulations ledger 506, a concept filter 602, web crawler 604, data site 606, a privacy auditor 508, an alert generator 608, a privacy remediator 514, and an ameliorative action 512. The privacy auditor 508 configures the web crawler 604 with the concept filter 602 and the web crawler 604 analyzes the data site 606. The web crawler 604 detects information on the data site 606, which is not congruent with the personal privacy settings ledger 504, and the personal privacy regulations ledger 506. The web crawler 604 notifies the privacy auditor 508 and the privacy auditor 508 notifies the privacy remediator 514. The alert generator 608 receives the notification and generates an ameliorative action 512. The ameliorative action 512 may be, for example populating and transmitting a cease and desist form letter or may be accessing the data site 606 via an API and correcting the incongruence. The web crawler 604 may monitor and “crawl” websites for personal information, and may access and monitor personal information on distributed applications (DApps), for example, a blockchain-based distributed service, site, or application.

The system may monitor a user's data for inconsistencies and inaccuracies, and also to ensure that the level of data shared is not in excess of the user's specified level of sharing. They system may then reduce the amount of data that that is shared to match the user's intention as specified in other parts of the of the client's user interface. For example, on the privacy settings if a user has decided not to share location data, the system may notify the user that they have location turned off and have shared something with location data associated with it. If the system or the user finds information that may have been previously shared on the Internet, but the user no longer wants it to be public, the system may send a notification signal to the site or generate a cease-and-desist letter to the site's operator. The system may employ a filter to screen sites for specific information, for example, the user may configure the system to scan their social media pages for embarrassing or inappropriate content. For example, prior to applying for a job, a user may wish to ensure their social media page does not have anything which might appear inappropriate to a potential employer. The system may accomplish this by implementing, for example, a keyword filter or a concept filter 602.

The privacy auditor 508 (or a separate component that interacts with the privacy auditor 508, not depicted) may input control settings from a number of sources, such as the personal privacy settings ledger 504, the personal privacy regulations ledger 506, the enterprise role policies 520, the enterprise privacy regulations ledger 526, and the enterprise privacy settings ledger 528. The privacy auditor 508 may operate a policy translator 614 formulate these settings into a prioritized hierarchy in an associative memory structure 610. Settings for a same or similar type of data (e.g., a particular element of private data such as a user's tracked location) may be indexed (e.g., tagged) similarly in the associative memory structure 610. For example, the associative memory structure 610 may take the form of a collection of “rows” with tags associating data elements, roles, and priorities. For example a row may have the form: <element: location data><user: johnsmith><role: personal><priority: 2><sharing permissions: permission_mask><dependencies: dependencies_list[ ]>. The ‘permission mask’ in this example is a binary-coded mask, where a bit position is set or not to provide a control setting for an enumerated data sharing permission. The dependency list identifies other data elements that should be shared (or that can't be shared) along with the data element defined in the row. The contention resolution 612 harmonizes any conflicts in the priorities, dependencies, and/or permissions between the different roles for a given user and data element.

In view of this description and the drawings, it will be readily apparent to those of ordinary skill in the art how to implement the privacy auditor 508 and privacy remediator 514, for example via extension of well-known open-source software libraries. Other components of the data privacy system 500 and data privacy system 600, such as the device monitor 518 and concept filter 602, are available in existing commercial tools and libraries.

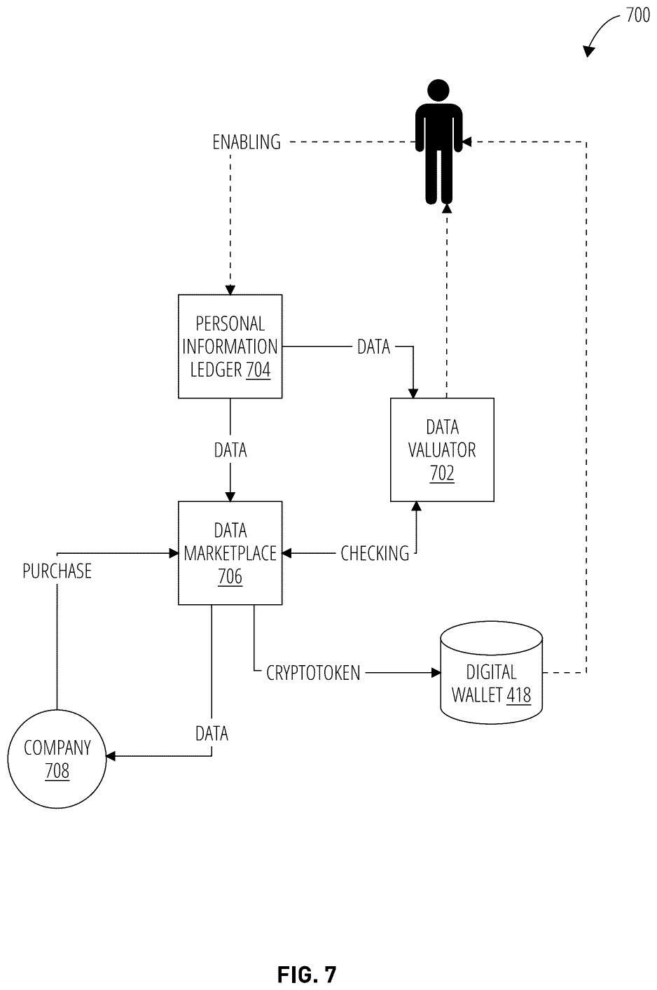

Referring now to FIG. 7, a data privacy system 700 comprises a digital wallet 418, a data valuator 702, a personal information ledger 704, a data marketplace 706, and a company 708. The user may enable the data privacy system 700 to transmit data from the personal information ledger 704 to the data marketplace 806. The data valuator 702 may utilize known valuation calculators to provide the user with a value approximation of their data. The personal information ledger 704 may also record market prices for the user's data to provide the user with an actual value. The company 708 may purchase data from the data marketplace 706 and the user may receive a crypto token in a digital wallet 418.

The system enables users to receive compensation for the use of their personal data, and the level of compensation may be determined by the value of the individual's data. For example, a user with more social media followers may be more valuable to a company looking to connect with “influencers,” or a different company may be more interested in users who purchase a large quantity of items online in a specific demographic. To establish a value for a user's data, the system may utilize a market where entities may bid on user information. This would enable natural market effects to establish the value of each user's information. Alternatively, the system may utilize commonly known value evaluation techniques. In addition to enabling companies better access to user data, this gives the user a sense of how much their data is worth at any given time-for example, shopping habits, and demographic information. The system may employ conventional data evaluation techniques used in digital advertising. If a user's data is purchased by a company or a data broker, the system may make a deposit into a bank account or crypto wallet. The system may ingest personal data and metadata with fields corresponding to different information. The user may also input their personal data into these fields. The user may then set sharing controls to set the privacy permissions for each piece of data. These may be default controls that can be set individually by site or decentralized application and the controls may indicate the site's identity and what type of site or service it is, for example, news site vs. social media site.

The user may decide to share their personal data with a third party in exchange for a reward, which may be transmitted to the user's digital wallet. The system may employ a distributed ledger or blockchain to record transactional information. The user may also store other data on the blockchain as well. For example, the user may store “binary large objects” AKA BLOBs of data on the blockchain. The user may have opportunities to provide richer forms of data, for additional rewards and incentives, for example, participating in surveys, focus groups referrals, enabling data sharing inferred by certain privacy and opt in settings, etc. The system manages the user's privacy across all sites so regardless of updates to privacy policies, a user's data remains protected and their privacy settings on the social media site maintain parity with the system's privacy settings.

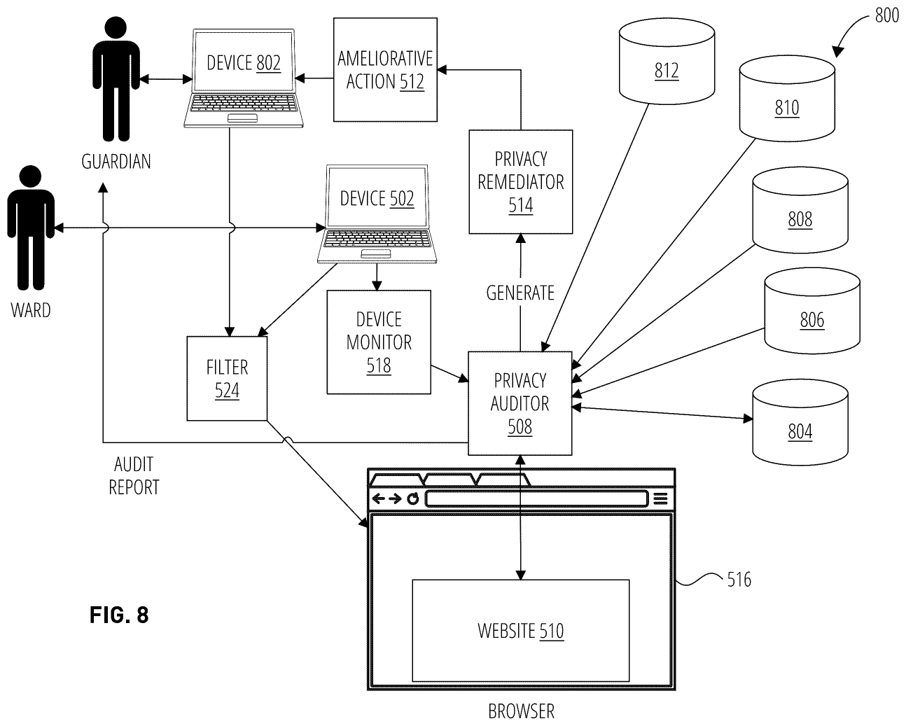

FIG. 8 depicts a system 800 for third-party management of data privacy, in one embodiment. As depicted the system 800 enables a guardian (e.g., a legally-appointed adult) to manage and control privacy and data sharing by a ward (e.g., a minor, a disabled person, or an elderly person). More generally, the system 800 enables a third party to manage and control data privacy and sharing by any other person, e.g., the guardian could be a manager or director (employee or third party contractor/vendor) that manages and controls data privacy and sharing by enterprise employees or other contractors/vendors; or, the guardian could be a person that does these things for a celebrity, high net worth individual; and so on. The system comprises some components of the data privacy system 500, along with a computing device 802 used by the guardian, a ward privacy settings ledger 804, an institution privacy settings ledger 806, a guardian policies ledger 808, an institution privacy regulations ledger 810, and a ward privacy regulations ledger 812.

In the depicted example, the guardian manages and controls privacy and data sharing by the ward via a computing device 802. The guardian may receive audit reports to document compliance with various regulations and privacy/data sharing control settings in the various ledgers.

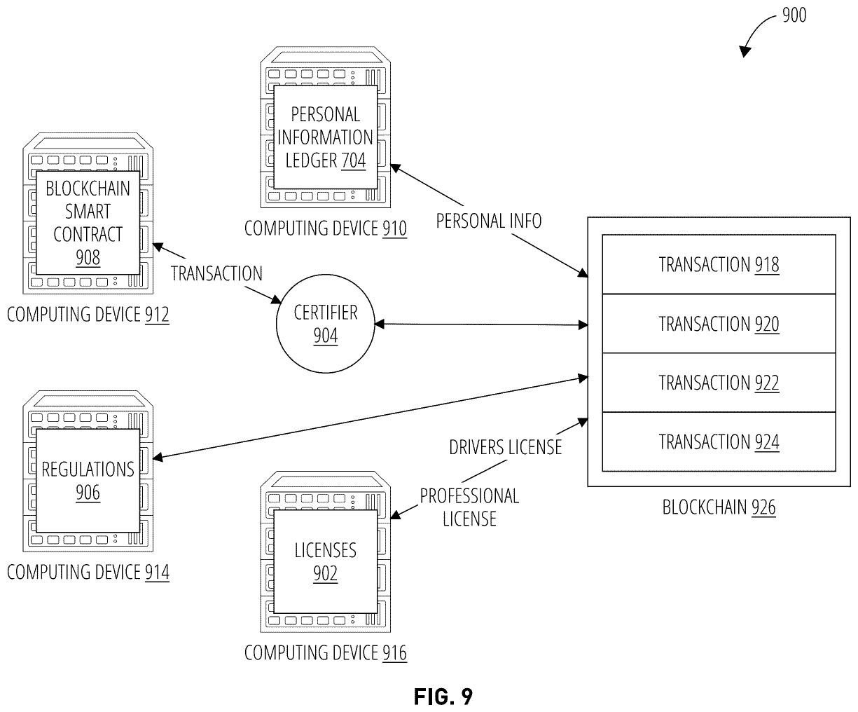

Referring now to FIG. 9, a blockchain 900 comprises a license 902, a certifier 904, a personal information ledger 704, regulations 906, a blockchain smart contract 908, a blockchain smart contract 908, a computing device 910, a computing device 912, a computing device 914, a computing device 916, a transaction 918, a transaction 920, a transaction 922, a transaction 924, and a blockchain 926. The computing device 910 transmits personal information ledger 704 to the blockchain 926. The computing device 912 transmits the blockchain smart contract 908 to the blockchain 926 via the certifier 904.

The computing device 914 records the regulations 906 on the blockchain 926, and the computing device 916 records the licenses 902 on the blockchain 926. The licenses 902, regulations 906, blockchain smart contract 908 and personal information ledger 704 may be recorded on the blockchain 926 as the transaction 918 the transaction 920, the transaction 922, and the transaction 924. The blockchain 926 may be distributed on the computing device 912, the computing device 910, the computing device 916, and the computing device 914.

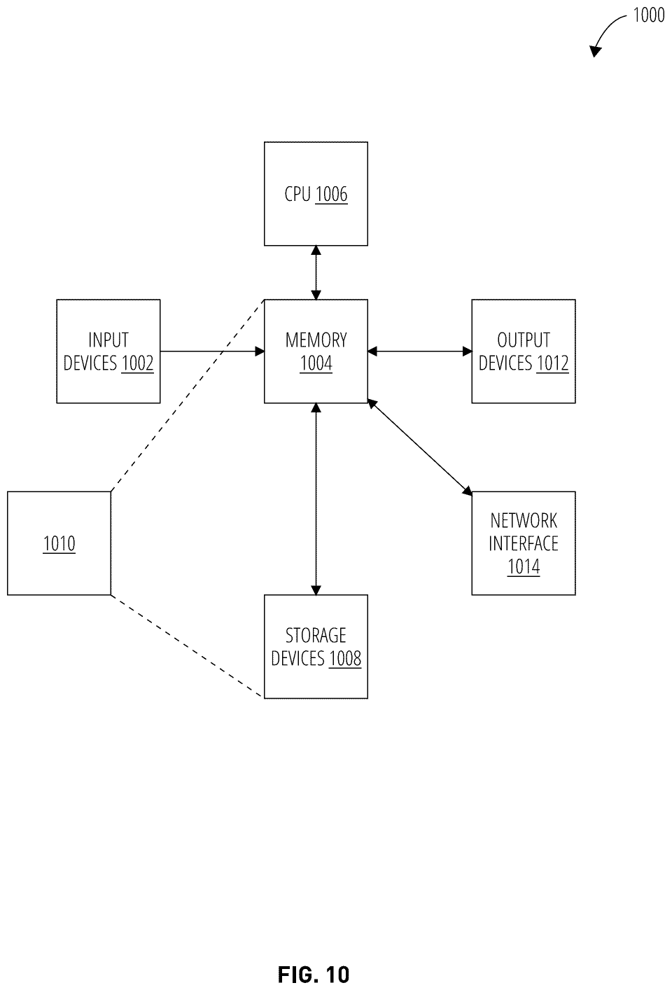

FIG. 10 depicts an embodiment of a digital apparatus 1000 to implement components and process steps of the system described herein.

Input devices 1002 comprise transducers that convert physical phenomenon into machine internal signals, typically electrical, optical or magnetic signals. Signals may also be wireless in the form of electromagnetic radiation in the radio frequency (RF) range but also potentially in the infrared or optical range. Examples of input devices 1002 are keyboards which respond to touch or physical pressure from an object or proximity of an object to a surface, mice which respond to motion through space or across a plane, microphones which convert vibrations in the medium (typically air) into device signals, scanners which convert optical patterns on two or three-dimensional objects into device signals. The signals from the input devices 1002 are provided via various machine signal conductors (e.g., busses or network interfaces) and circuits to memory 1004.

The memory 1004 is typically what is known as a first or second level memory device, providing for storage (via configuration of matter or states of matter) of signals received from the input devices 1002, instructions and information for controlling operation of the CPU 1006, and signals from storage devices 1008.

The memory 1004 and/or the storage devices 1008 may store computer-executable instructions and thus forming logic 1010 that when applied to and executed by the CPU 1006 implement embodiments of the processes disclosed herein.

Information stored in the memory 1004 is typically directly accessible to the CPU 1006 of the device. Signals input to the device cause the reconfiguration of the internal material/energy state of the memory 1004, creating in essence a new machine configuration, influencing the behavior of the digital apparatus 1000 by affecting the behavior of the CPU 1006 with control signals (instructions) and data provided in conjunction with the control signals.

Second or third level storage devices 1008 may provide a slower but higher capacity machine memory capability. Examples of storage devices 1008 are hard disks, optical disks, large capacity flash memories or other non-volatile memory technologies, and magnetic memories.

The CPU 1006 may cause the configuration of the memory 1004 to be altered by signals in storage devices 1008. In other words, the CPU 1006 may cause data and instructions to be read from storage devices 1008 in the memory 1004 from which may then influence the operations of CPU 1006 as instructions and data signals, and from which it may also be provided to the output devices 1012. The CPU 1006 may alter the content of the memory 1004 by signaling to a machine interface of memory 1004 to alter the internal configuration, and then converted signals to the storage devices 1008 to alter its material internal configuration. In other words, data and instructions may be backed up from memory 1004, which is often volatile, to storage devices 1008, which are often non-volatile.

Output devices 1012 are transducers which convert signals received from the memory 1004 into physical phenomenon such as vibrations in the air, or patterns of light on a machine display, or vibrations (i.e., haptic devices) or patterns of ink or other materials (i.e., printers and 3-D printers).

The network interface 1014 receives signals from the memory 1004 and converts them into electrical, optical, or wireless signals to other machines, typically via a machine network. The network interface 1014 also receives signals from the machine network and converts them into electrical, optical, or wireless signals to the memory 1004.

### LISTING OF DRAWING ELEMENTS

100 system
102 gateway
104 normalizer
106 content
108 content
110 exploit analyzer
112 collector
114 fraud detector
116 curator
118 certifier
120 content controller
122 data triangulator
124 user interface
126 distributor
200 process for managing personal data
202 block
204 block
206 block
208 block
210 block
212 block
300 process for managing ID health
302 block
304 block
306 block
308 block
310 block
400 reward and data sharing process
402 block
404 block
406 block
408 block
410 block
412 block
414 block
416 block
418 digital wallet
420 blockchain ledger
500 data privacy system
502 device
504 personal privacy settings ledger
506 personal privacy regulations ledger
508 privacy auditor
510 website
512 ameliorative action
514 privacy remediator
516 browser
518 device monitor
520 enterprise role policies
522 enterprise
524 filter
526 enterprise privacy regulations ledger
528 enterprise privacy settings ledger
600 data privacy system
602 concept filter
604 web crawler
606 data site
608 alert generator
610 associative memory structure
612 contention resolution
614 policy translator
700 data privacy system
702 data valuator
704 personal information ledger
706 data marketplace
708 company
800 system
802 device
804 ward privacy settings ledger
806 institution privacy settings ledger
808 guardian policies ledger
810 institution privacy regulations ledger
812 ward privacy regulations ledger
900 blockchain
902 licenses
904 certifier
906 regulations
908 blockchain smart contract
910 computing device
912 computing device
914 computing device
916 computing device
918 transaction
920 transaction
922 transaction
924 transaction
926 blockchain
1000 digital apparatus
1002 input devices
1004 memory
1006 CPU
1008 storage devices
1010 logic
1012 output devices
1014 network interface

Terms used herein should be accorded their ordinary meaning in the relevant arts, or the meaning indicated by their use in context, but if an express definition is provided, that meaning controls.

“Circuitry” in this context refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Firmware” in this context refers to software logic embodied as processor-executable instructions stored in read-only memories or media.

“Hardware” in this context refers to logic embodied as analog or digital circuitry.

“Logic” in this context refers to machine memory circuits, non-transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Software” in this context refers to logic implemented as processor-executable instructions in a machine memory (e.g. read/write volatile or nonvolatile memory or media).

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

Various logic functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

1.-20. (canceled)

21. A system comprising:
an enterprise Mobile Device Management (MDM) control system configured to selectively control actions on and access to personal information by a web browser based on a combination of signals from a plurality of authorization control modules;
an auditor configured to retrieve website personal information and privacy settings in response to a signal indicating navigation to the website by the web browser;
validation logic configured to:
(a) perform a first comparison of the website personal information by the auditor against first blockchain records;
(b) generate a first alert on condition that the first comparison indicates a first incongruity;
(c) perform a second comparison of website privacy settings website second blockchain records encoding personal privacy settings and enterprise privacy settings;
(d) generate a second alert on condition that the second comparison indicates a second incongruity;
(e) perform a third comparison of the website privacy settings against third blockchain records encoding personal privacy regulations and enterprise privacy regulations for a jurisdiction;
(f) generate a third alert on condition that the third comparison indicates a third incongruity;
(g) harmonize and prioritize control settings for the personal information based on the first comparison, the second comparison, and the third comparison;
(h) constrain actions on the personal information based on fourth blockchain records comprising enterprise role policies encoded as digital contract entitlements; and
a remediator configured to generate an ameliorative action for the personal information on the website response to one or more of the first alert, the second alert, and the third alert.

22. The system of claim 21, wherein at least some of the authorization control modules are associated with particular partitions of one or more mobile computing devices.

23. The system of claim 21, wherein the fourth blockchain records further comprise jurisdiction-specific digital contract entitlements.

24. The system of claim 21, wherein the constrained actions comprise sales, licensing, and sharing actions on the personal information.

25. The system of claim 21, wherein the auditor is further configured to:
harmonize and prioritize the control settings for the personal information based a device-monitor-determined role of a person operating the web browser.

26. The system of claim 21, where the control settings are configured into a hierarchical structure such that enterprise role policies supervene on personal privacy settings for a device operated by a person in an individual role capacity.

27. The system of claim 21, wherein the auditor is implemented as an artificial intelligence bot agent.
